(19) United States
(12) Patent Application Publication
(10) Pub. No.: US 2025/0307845 A1
(43) Pub. Date: Oct. 2, 2025

(54) METHODS AND SYSTEMS FOR PRODUCT AUTHENTICATION AT AN AUTHENTICATION SERVER

(71) Applicant: Proqure, Inc., Pleasanton, CA (US)

(72) Inventors: Paul Brandon Butler, San Francisco, CA (US); Don Errigo, Pleasanton, CA (US); Ami Barda, Perth (AU); Ori Demb, Perth (AU); Giampaolo Marino, Star, ID (US)

(21) Appl. No.: 19/065,768

(22) Filed: Feb. 27, 2025

Related U.S. Application Data
(60) Provisional application No. 63/570,621, filed on Mar. 27, 2024.

(51) Int. Cl. G06Q 30/018; G06K 7/10

(52) U.S. Cl. CPC G06Q 30/0185; G06K 7/10366

(57) ABSTRACT

Examples of methods and systems for product authentication are disclosed. In an example, a method for authenticating an NFC label involves receiving a first message that includes a label ID and a first cipher code from a mobile device, generating a second cipher code in response to receiving the first message, transmitting an engage again message to the mobile device in response to determining that the first cipher code matches the second cipher code, receiving a second message that includes a label ID and a third cipher code from the mobile device after the engage again message is transmitted to the mobile device, generating a fourth cipher code in response to receiving the second message, and transmitting an authentication successful message to the mobile device in response to determining that the third cipher code matches the fourth cipher code.

### CROSS-REFERENCE TO RELATED APPLICATION

This application claims priority to U.S. Provisional Patent Application Ser. No. 63/570,621, filed Mar. 27, 2024, which is incorporated by reference herein, and is related to co-pending U.S. Patent Application Ser. Number XX/XXX,XXX, filed February XX, 2025, entitled METHODS AND SYSTEMS FOR PRODUCT AUTHENTICATION THAT INCLUDE AN INTEGRATED CIRCUIT DEVICE.

### BACKGROUND

NFC (Near Field Communication) labels have emerged as a powerful tool for authenticating high-value packaged products, such as premium wines and luxury perfumes. Such NFC labels, which store unique, tamper-proof digital information, can be embedded in product labeling or packaging and used by consumers to verify the product's authenticity. For example, consumers can use a smartphone or other NFC-enabled device to scan an NFC label to instantly access details about the product's origin and production process as well to verify the authenticity of the product. As NFC labels become more widely adopted, bad actors will continue to try to circumvent the protections provided by NFC labels in order to sell counterfeit products. Thus, there is a continued need to provide NFC-based techniques for product authentication that are reliable, easy to use, and cost effective.

### SUMMARY

Examples of methods and systems for product authentication are disclosed. In an example, a method for authenticating an NFC label involves receiving a first message that includes a label ID and a first cipher code from a mobile device, generating a second cipher code in response to receiving the first message, transmitting an engage again message to the mobile device in response to determining that the first cipher code matches the second cipher code, receiving a second message that includes a label ID and a third cipher code from the mobile device after the engage again message is transmitted to the mobile device, generating a fourth cipher code in response to receiving the second message, and transmitting an authentication successful message to the mobile device in response to determining that the third cipher code matches the fourth cipher code.

In an example, the second cipher code is generated from the first cipher code using at least one key that is obtained using the label ID that is received in the first message, and the fourth cipher code is generated from the third cipher code using at least one key that is obtained using the label ID that is received in the second message.

In an example, generating the second cipher code involves decoding the first cipher code using at least one key that is obtained using the label ID that is received in the first message to produce a decoded output and encoding the decoded output using the at least one key to generate the second cipher code, and generating the fourth cipher code involves decoding the third cipher code using at least one key that is obtained using the label ID that is received in the second message to produce a decoded output and encoding the decoded output using the at least one key to generate the fourth cipher code.

In an example, the method further involves comparing the first cipher code to the second cipher code at an authentication server, and comparing the third cipher code to the fourth cipher code at the authentication server.

In an example, the first message includes a URL and the second message includes a URL, wherein the URL in the first message matches the URL in the second message, and further comprising comparing the first cipher code to the second cipher code at an authentication server that is accessed via the URL, and comparing the third cipher code to the fourth cipher code at the authentication server.

In an example, the authentication server includes a database of keys that are indexed by label ID.

In an example, the authentication server is configured to generate the second cipher code and the fourth cipher code using an encryption algorithm, which is the same as an encryption algorithm that is used by an NFC IC device that corresponds to the label ID.

In an example, the label ID received in the first message matches the label ID received in the second message, and wherein the second cipher code and the fourth cipher code are generated from a key that is obtained using the label ID.

In an example, the first cipher code and the third cipher code are generated at an NFC label that is affixed to a product and wherein the NFC label receives electromagnetic energy from the mobile device.

Another example of a method for authenticating an NFC label is disclosed. The method involves receiving a first message that includes a label ID and a first cipher code from a mobile device, generating a second cipher code from the first cipher code using the label ID from the first message, determining if the first cipher code matches the second cipher code, transmitting an engage again message to the mobile device in response to determining that the first cipher code matches the second cipher code, or an authentication failed message to the mobile device in response to determining that the first cipher code does not match the second cipher code, receiving a second message that includes a label ID and a third cipher code from the mobile device after the engage again message is transmitted to the mobile device, generating a fourth cipher code from the third cipher code using the label ID from the second message, determining if the third cipher code matches the fourth cipher code, and transmitting an authentication successful message to the mobile device in response to determining that the third cipher code matches the fourth cipher code, or an authentication failed message to the mobile device in response to determining that the first cipher code does not match the second cipher code.

In an example, generating the second cipher code involves decoding the first cipher code using at least one key that is obtained using the label ID that is received in the first message to produce a decoded output and encoding the decoded output using the at least one key to generate the second cipher code, and generating the fourth cipher code involves decoding the third cipher code using at least one key that is obtained using the label ID that is received in the second message to produce a decoded output and encoding the decoded output using the at least one key to generate the fourth cipher code.

In an example, the method further involves comparing the first cipher code to the second cipher code at an authentication server, and comparing the third cipher code to the fourth cipher code at the authentication server.

In an example, the first cipher code and the third cipher code are generated in an NFC label that is affixed to a product and wherein the NFC label receives electromagnetic energy from the mobile device.

Another example of a method for authenticating an NFC label is disclosed. The method involves at an authentication server, receiving a label ID and a first cipher code from a mobile device, generating a second cipher code from the first cipher code using the label ID received with the first cipher code, generating an engage again message for transmission to the mobile device in response to determining that the first cipher code matches the second cipher code, receiving a label ID and a third cipher code from the mobile device after the engage again message is transmitted to the mobile device, generating a fourth cipher code from the third cipher code using the label ID received with the third cipher code, and generating an authentication successful message for transmission to the mobile device in response to determining that the third cipher code matches the fourth cipher code.

In an example, the second cipher code is generated from the first cipher code using at least one key that is obtained using the label ID that is received with the first cipher code, and the fourth cipher code is generated from the third cipher code using at least one key that is obtained using the label ID that is received with the third cipher code.

In an example, generating the second cipher code involves decoding the first cipher code using at least one key that is obtained using the label ID that is received with the first cipher code to produce a decoded output and encoding the decoded output using the at least one key to generate the second cipher code, and generating the fourth cipher code involves decoding the third cipher code using at least one key that is obtained using the label ID that is received with the third cipher code to produce a decoded output and encoding the decoded output using the at least one key to generate the fourth cipher code.

In an example, the method further includes comparing the first cipher code to the second cipher code at an authentication server, and comparing the third cipher code to the fourth cipher code at the authentication server.

In an example, the authentication server includes a database of keys that are indexed by label ID.

In an example, the authentication server is configured to generate the second cipher code and the fourth cipher code using an encryption algorithm that is also used by an NFC IC device that corresponds to the label ID.

In an example, the first cipher code and the second cipher code are generated in an NFC label that is affixed to a product and wherein the NFC label receives electromagnetic energy from the mobile device.

Another example of a method for authenticating an NFC label is disclosed. The method includes receiving a first message that includes a label ID and a first cipher code from a mobile device, obtaining a seed key and an algorithmic key using the label ID, generating a second cipher code from the first cipher code using the seed key and the algorithmic key that were obtained using the label ID, and authenticating the NFC label in response to the second cipher code matching the first cipher code.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 illustrates an example of an authentication process that involves interaction between a user, a mobile device, a product, an NFC label affixed to the product, and an authentication server that is accessed through a computer network.

FIG. 2 illustrates interactions between a mobile device and an NFC label relative to an operating volume that is formed between the mobile device and the NFC label.

FIG. 3A depicts an example of an electrical signal that is generated at the NFC label in response to tap #1 from FIG. 2.

FIG. 3B depicts an example of an electrical signal 326 that is generated at the NFC label in response to tap #2 from FIG. 2.

FIG. 3C depicts an example of an electrical signal 328 that is generated at the NFC label in response to tap #3 from FIG. 2.

FIG. 4 illustrates examples of cipher codes that are generated from the three different taps described with reference to FIGS. 2 and 3A-3C.

FIG. 5A depicts an example of an NFC label that includes an NFC tag that is integrated with a label substrate.

FIG. 5B depicts the NFC antenna and an expanded view of the NFC IC device from FIG. 5A.

FIG. 6 is a block diagram of an example of an NFC IC device that may be part of an NFC label that is used to implement the product authentication processes described herein.

FIG. 7 is a functional block diagram of an encoder of the NFC IC device from FIG. 6.

FIG. 8 illustrates an example of operations of an NFC IC device that are implemented as part of an authentication process.

FIG. 9 is a swim lane diagram of a technique for authenticating a product that has an NFC label affixed thereon.

FIG. 10A is an example of a user interface that is displayed on the mobile device in response to a message received from the authentication server.

FIG. 10B is an example of another user interface that is displayed on the mobile device in response to the message received from the authentication server.

FIG. 11 is a swim lane diagram of a technique for authenticating a product that has an NFC label affixed thereon.

FIG. 12 is a process flow diagram of a method for validating a cipher code that is received from a mobile device that has interacted with an NFC label.

FIG. 13 is an example of a key database 1300 that stores keys that are indexed by label ID.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

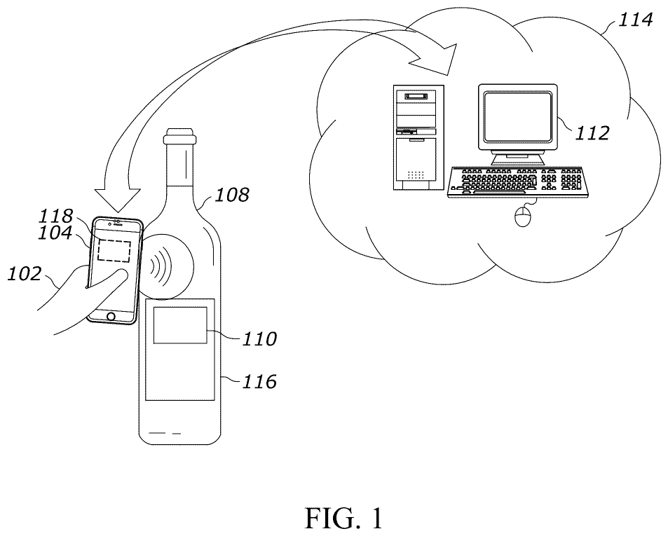

This disclosure relates to techniques for authenticating products using NFC labels affixed to the products. FIG. 1 illustrates an example of an authentication process that involves interaction between a user 102, a mobile device 104, a product 108, an NFC label 110 affixed to the product, and an authentication server 112 that is accessed through a computer network 114. In the example of FIG. 1, the product is a bottle of wine and the bottle of wine has the NFC label affixed to the product. For example, the NFC label is integrated with a product label 116 that is affixed, e.g. by adhesive, to an outer surface of the product packaging. In an authentication operation, the user brings the mobile device, e.g., a smartphone configured with an NFC reader, into close contact with the NFC label that is affixed to the product, which triggers an interaction between the NFC label, the mobile device, and the authentication server. In some conventional approaches to NFC-based product authentication, the NFC label stores a unique label identifier (ID) that is used by the authentication server to authenticate the product. While the NFC label stores a unique ID that is used for authentication of the product, the unique identifier may be surreptitiously read from the NFC label or obtained through a side channel attack and applied to counterfeit products. For example, the unique ID can be cloned and applied to multiple counterfeit products. Some obstacles to counterfeiting and/or cloning can be put in place by adding advanced functionality to the NFC labels, which may add cost to the NFC label and thus to the corresponding product. Additionally, some NFC-based authentication techniques require an App to be downloaded and installed onto the smartphone to facilitate the authentication process. However, it has been realized that certain aspects of an NFC label may be leveraged to implement a technique for authenticating products that is highly secure, cost effective, and that does not require an App to be downloaded. In particular, a novel technique for authenticating products leverages a physically unclonable function (PUF) that corresponds to the interaction between a mobile device and an NFC label to generate at least one cipher code at the NFC label that is then used by the authentication server to authenticate the product. In an example, multiple interactions between the mobile device and the NFC label can be used to protect against cloning of NFC labels. As is described herein, the disclosed technique for authenticating a product is highly secure, very difficult to clone, is cost effective, and does not require an App to be downloaded to the mobile device. Thus, the technique for product authentication is a significant roadblock to counterfeiters while providing a great customer experience.

In order to implement the techniques described herein, a mobile device should be equipped with NFC capability. For example, the mobile device is a smartphone that is equipped with an NFC reader that includes an NFC Integrated Circuit (IC) device and a corresponding antenna (e.g., NFC antenna) that is electrically coupled to the NFC IC device. In an example, the NFC antenna is located near the top or back of the smartphone, close to the rear camera module or slightly below the rear camera module. In most smartphones, the NFC antenna of the NFC reader is integrated into the back panel or positioned near a wireless charging coil of the smartphone, as these areas provide a compact space for the NFC antenna to function effectively. The exact location of the NFC antenna in the mobile device may vary depending on the form factor of the mobile device, but the NFC antenna is typically positioned to make it easy for a user to engage another NFC device, such as another NFC reader or an NFC tag, by bringing the mobile device into close proximity, usually within a few centimeters, to the target NFC reader or NFC tag. In the example of FIG. 1, the mobile device 104 is a handheld mobile device such as a smartphone that is equipped with an NFC reader 118 to provide NFC capability. In other examples, the mobile device may be a wearable device, such as a device worn on the wrist (e.g., smartwatch or health tracker), a device worn on the finger (e.g., a smart ring), smart glasses, or some other mobile computing device that is equipped with NFC capability and some other wide area wireless communication capability such as WiFi or cellular.

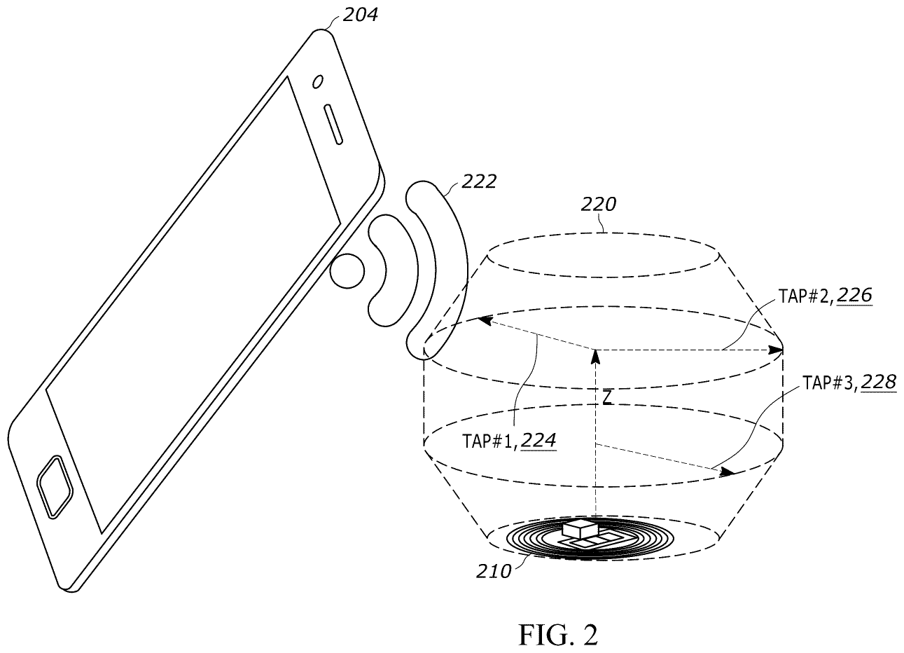

As described above, the techniques for authenticating products leverage a physically unclonable function (PUF) that corresponds to interactions between a mobile device and an NFC label to produce unique cipher codes at the NFC label. FIG. 2 illustrates interactions between a mobile device 204 and an NFC label 210 relative to an operating volume 220 that is formed between the mobile device and the NFC label during the interactions. The operating volume illustrated in FIG. 2 is a three-dimensional space in which the NFC-capable mobile device and the NFC label can exchange data utilizing electromagnetic energy 222 that is projected from the mobile device. In the example of FIG. 2, the mobile device has NFC capability (e.g., includes an NFC reader) and the NFC label would be affixed to a product such as a bottle of wine (not shown). In a typical interaction between the mobile device and the NFC label, a user brings the mobile device into close proximity to the NFC label. For example, a user taps the mobile device against the NFC label or brings the mobile device to within about 10 cm of the NFC label. In one common example, a user touches a back surface of the mobile device against the NFC label in a tapping motion. The interaction between the mobile device and the NFC label (e.g., the tap) has physical characteristics in both space and time. For example, the physical characteristics correspond to the path (space) that the mobile device travels relative to the NFC label both towards the NFC label and away from the NFC label and to the timing (time) of the travel between the mobile device and the NFC label. Because of the large number of possible variations in paths and timing of each interaction between the mobile device and the NFC label (e.g., variations between each tap), each interaction between the mobile device and the NFC label will have unique physical characteristics. As described below, the unique physical characteristics of each interaction between the mobile device and the NFC label are at least one component of the PUF that is leveraged to produce unique cipher codes at the NFC label.

With reference to FIG. 2, three separate interactions (e.g., taps) between the mobile device and the NFC label are represented by three separate vectors (Tap #1, 224; Tap #2, 226, and Tap #3, 228) in the operating volume between the mobile device and the NFC label. As illustrated by the three separate vectors in FIG. 2, each one of the three separate interactions between the mobile device and the NFC label has different physical characteristics in space and time. The different physical characteristics in space and time correspond to different electrical characteristics that can be captured at the NFC label. For example, the physical characteristics in space and time of each interaction translate to different electrical characteristics that can be translated to electrical signals at the NFC label. In an example, the NFC label converts the unique electrical characteristics of a particular interaction between the mobile device and the NFC label to an electrical signal and uses the electrical signal to generate an interaction-specific cipher code. That is, the unique electrical characteristics of a particular interaction between the mobile device and the NFC label correspond to a PUF that can be leveraged at the NFC label to produce PUF-based cipher codes.

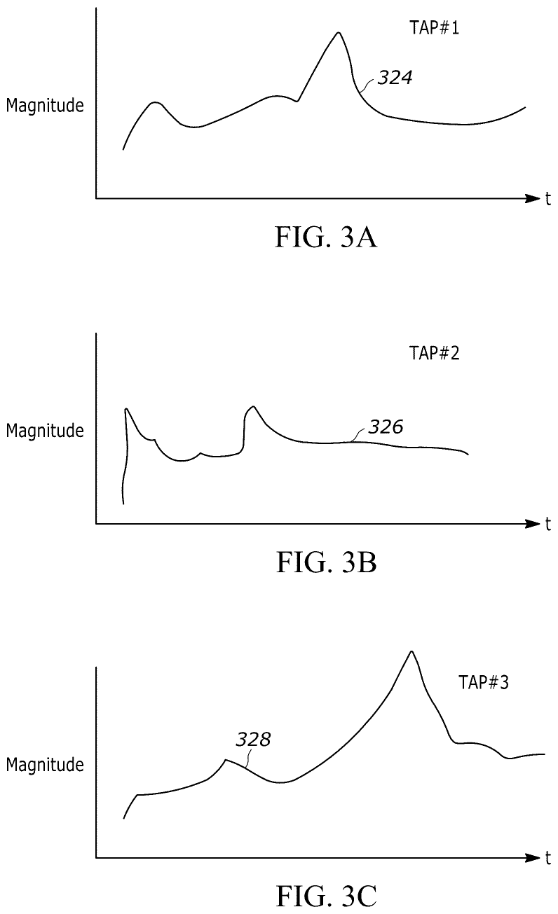

As described above with reference to FIG. 2, each interaction between the mobile device 204 and the NFC label 210 has unique physical characteristics that are translated to unique interaction-specific electrical characteristics at the NFC label. FIG. 3A-3C depicts three examples of electrical signals that may be generated at the NFC label in response to the three different interactions between the mobile device 204 and the NFC label 210 (e.g., three different taps) illustrated in FIG. 2. In particular, FIG. 3A depicts an example of an electrical signal 324 that is generated at the NFC label in response to tap #1 from FIG. 2, FIG. 3B depicts an example of an electrical signal 326 that is generated at the NFC label in response to tap #2 from FIG. 2, and FIG. 3C depicts an example of an electrical signal 328 that is generated at the NFC label in response to tap #3 from FIG. 2. In the examples of FIGS. 3A-3C, the electrical signals are represented as a graph of magnitude versus time, where the magnitude may be a measure of, for example, current or voltage. As illustrated in FIGS. 3A-3C, the three different electrical signals have three different profiles. It is the unique profile of the electrical signals that correspond to the dynamic nature of each interaction between the mobile device and the NFC label that makes up at least one component of the PUF that is leveraged to produce unique cipher codes at the NFC label. In another example, the electrical signals that are generated at the NFC label in response to interactions between the mobile device and the NFC label can be represented as a graph of complex impedance versus frequency.

It should be understood that the unique electrical characteristics of the electrical signals that are generated at the NFC label 210 in response to interactions between the mobile device 204 and the NFC label may be captured by the NFC label and/or represented graphically in different ways and FIGS. 3A-3C are provided to convey the understanding that each interaction between the mobile device and the NFC label results in a unique electrical signal at the NFC label. The unique electrical signal that is generated at the NFC label and that corresponds to each interaction between the mobile device and the NFC label can be converted to digital signals that form a “digital signal signature.” The digital signal signature corresponds to at least one parameter of the electromagnetic energy that is received at the NFC label. For example, the digital signal signature may correspond to a magnitude of current or voltage as a function of time and/or to a complex impedance as a function of frequency. The digital signal signature of an interaction may correspond to other parameters of the electromagnetic energy that is received at the NFC label. As is described below, at least a portion of the digital signal signature of each tap is utilized as a PUF at the NFC label to generate a unique cipher code.

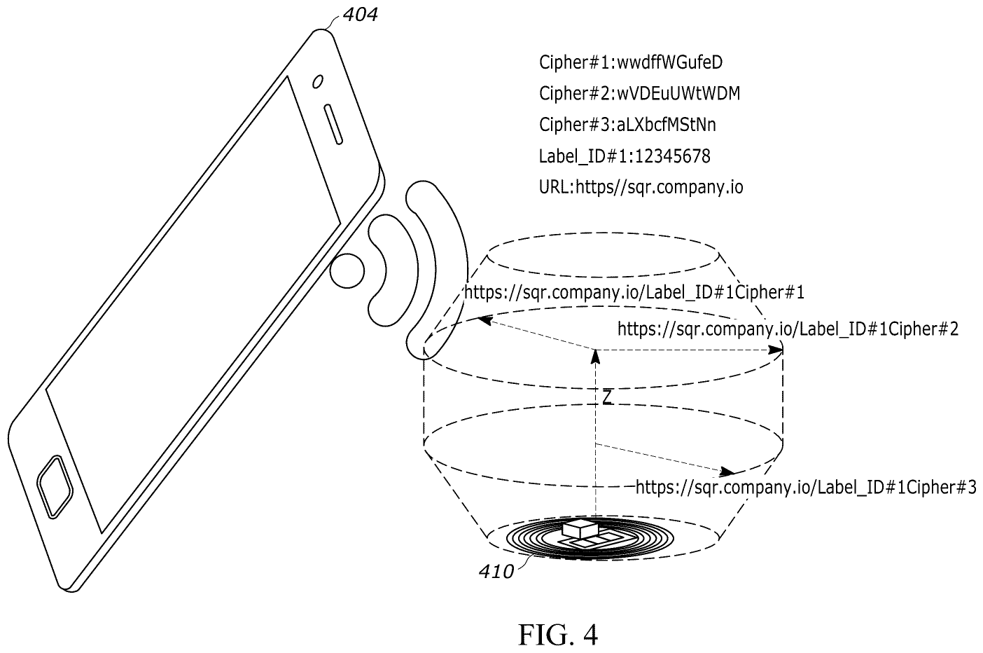

As is described herein, an NFC label generates a unique cipher code from each tap of a mobile device onto the NFC label. FIG. 4 illustrates examples of cipher codes that are generated from the three different taps described with reference to FIGS. 2 and 3A-3C. As illustrated in FIG. 4, cipher code #1 (e.g., wwdffWGufeD) is generated in response to a digital signal signature that is generated from tap #1, cipher code #2 (e.g., wVDEuUWtWDM) is generated in response to a digital signal signature that is generated from tap #2, and cipher code #3 (e.g., aLXbcfMStNn) is generated in response to a digital signal signature that is generated from tap #3. As part of the product authentication process, the NFC label 410 will generate interaction-specific cipher codes and provide the cipher codes to the mobile device 404 via NFC communications. In an example, the NFC label provides a message to the mobile device in response to each tap of the mobile device onto the NFC label. In one example and as is described in more detail below, each message includes a URL, a label ID, and a tap-specific cipher code. In an example, the URL corresponds to the product to which the NFC label is fixed and the label ID is a unique identifier for the NFC label. For example, the label ID is a numeric value that uniquely identifies the particular NFC label. In the example of FIG. 4, the URL is “https://sqr.company.io”, and the label ID is “12345678”. In the example of FIG. 4, each message that is generated at the NFC label and sent to the mobile device includes the URL, the label ID, and an interaction-specific cipher code and each message is represented in the figure as “https://sqr.company.io/Label_ID #1Cipher #”. With regard to the three taps, the three separate messages that are sent from the NFC label are represented as:
Tap #1: https://sqr.company.io/12345678wwdffWGufeD;
Tap #2: https://sqr.company.io/12345678wVDEuUWtWDM; and
Tap #3: https: //sqr.company.io/12345678aLXbcfMStNn.

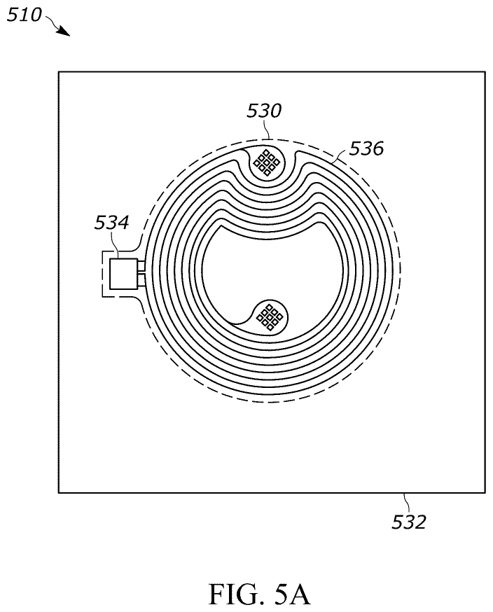

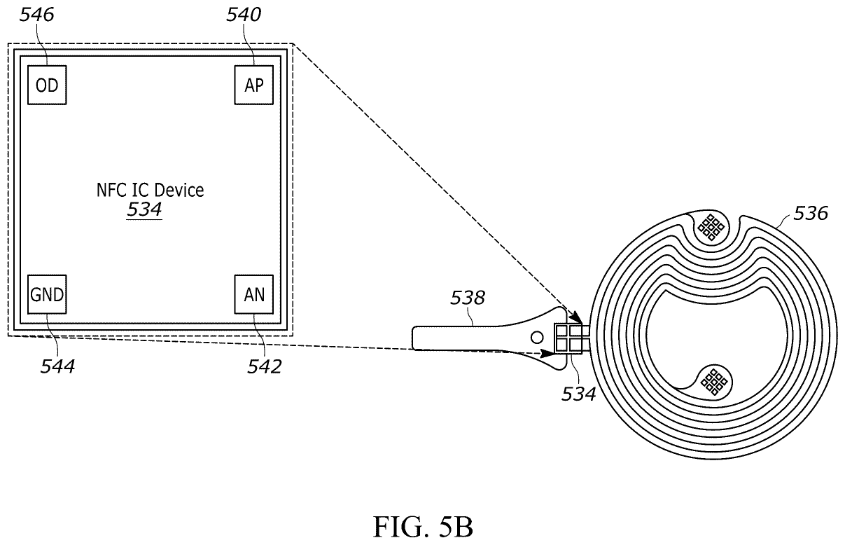

In an example, an NFC label includes an NFC tag that is integrated with a label substrate. The NFC tag includes an NFC IC device and an NFC antenna and the NFC IC device is electrically coupled to the NFC antenna. FIG. 5A depicts an example of an NFC label 510 that includes an NFC tag 530 that is integrated with a label substrate 532 in which the NFC tag includes an NFC IC device 534 and an NFC antenna 536 coupled to the NFC IC device. In an example, the label substrate may be a paper and/or plastic substrate with which the NFC tag is integrated. In the example of FIG. 5A, the NFC antenna is a coil antenna although other antenna configurations are possible. In an example, an NFC tag (including an NFC IC device and an NFC antenna) has a thin profile (e.g., on the order of 70 μm-1 mm thick), which can be integrated into a label substrate to form an NFC label that can be affixed to the packaging of a product similar to a traditional paper or plastic label that is affixed to the packaging of a product. In other examples, the NFC tag may be integrated into a label substrate to form an NFC label that is affixed to the product by some other means (e.g., a plastic tether) and accessible by a potential purchaser of the product. In an example, the NFC label may not be visible to a potential purchaser, but may be affixed to a product in a manner in which the NFC label is electrically accessible via NFC communications.

FIG. 5B depicts the NFC antenna 536 and an expanded view of the NFC IC device 534 from FIG. 5A. FIG. 5B also depicts an example of a tamper detection element 538 that may optionally be coupled to the NFC IC device. As shown in FIG. 5B, the NFC IC device includes electrical interfaces that include two antenna interfaces, antenna positive (AP) 540 and antenna negative (AN) 542, a ground interface (GND) 544, and an open detect interface (OD) 546. The antenna interfaces, AP and AN, can be electrically coupled to conductors of the NFC antenna and opposite ends of the tamper loop can be electrically coupled to the open detect interface, OD, and to the ground interface, GND. In an example, the interfaces of the NFC IC device are conductive pads that are exposed at an external surface of the NFC IC device.

In an example, the tamper detection element 538 can be used to determine if a product has been tampered with. For example, an OD tamper loop may be a conductive element that is positioned around the cork or cap of a bottle of liquor or perfume to provide an indication of whether or not the cork or cap has been removed from the corresponding container. In an example, the two ends of an OD tamper loop are connected to a pair of parallel plate paddles on either side of a product label to form a capacitor circuit. The capacitor circuit can be used to capacitively detect the presence of a liquid (or any substance with a dielectric property) in a bottle or package. The capacitor circuit could also be used to detect that the label has been tampered, e.g., peeled off the product package.

Although an example of an NFC label, an NFC tag, an NFC IC device, and an NFC antenna are described with reference to FIGS. 5A and 5B, other examples of an NFC label, NFC tag, an NFC IC device and/or an NFC antenna are possible.

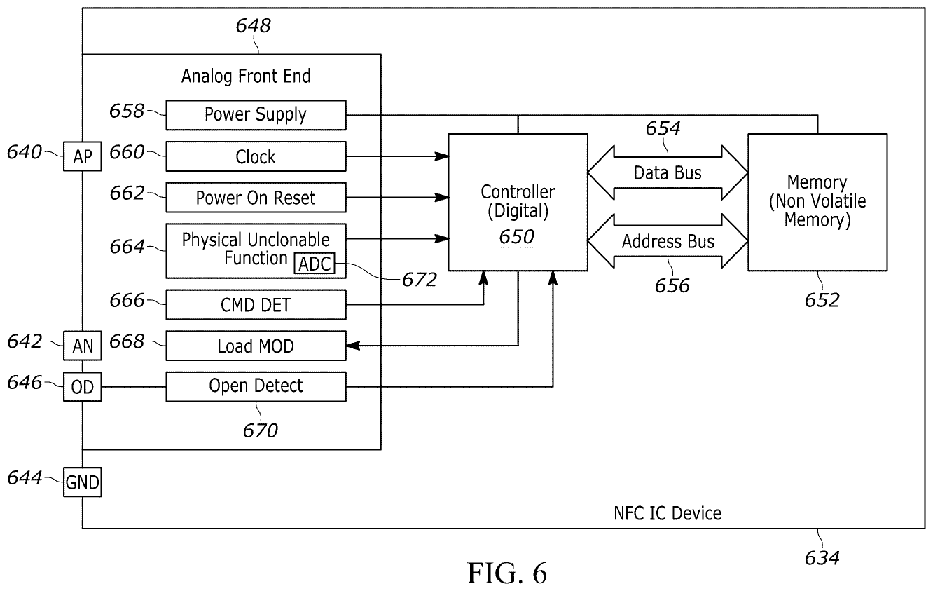

FIG. 6 is a block diagram of an example of an NFC IC device 634 that may be part of an NFC label that is used to implement the product authentication processes described herein. In an example, the NFC IC device includes an analog front end 648, a controller 650 (e.g., a digital controller), and a memory 652 (e.g., a non-volatile memory). In the example, a data bus 654 and an address bus 656 are coupled between the controller and the memory to provide data access between the controller and the memory. The analog front end includes a power supply 658, a clock 660, a power on reset (POR) 662, a physically unclonable function (PUF) 664, a command detect (CMD DET) 666, a load modulator (Load MOD) 668, and an open detect module 670. The NFC IC device may also include two antenna interfaces (antenna positive (AP) 640 and antenna negative (AN) 642), a ground interface (GND) 644, and an open detect interface (OD) 646 as described with reference to FIG. 5B. In operation, the analog front end of the NFC IC device generates a digital signal signature that corresponds to at least one parameter of electromagnetic energy that is received at the NFC IC device from a mobile device. As described above, the digital signal signature may correspond to a magnitude of current or voltage as a function of time generated at the analog front end and/or to a complex impedance as a function of frequency. The digital signal signature may correspond to other parameters of the electromagnetic energy that is received at the NFC label.

As described above, the unique physical characteristics (e.g., space and time) of each interaction between a mobile device and an NFC label are a component of the PUF that corresponds to interactions between a mobile device and an NFC label. Additional components of the PUF that correspond specifically to an NFC label may include physical characteristics of how the label is affixed to the product (e.g., adhesive thickness), physical characteristics of the label substrate, physical characteristics of the NFC tag, including unique characteristics of each specific NFC antenna, unique characteristics of electrical coupling between the NFC antenna and the NFC IC device, and unique characteristics of the circuits of the NFC IC device, such as unique characteristics that may result from manufacturing process variations. Additional factors that may be components of the PUF that correspond to interactions between a mobile device and an NFC label may include product packaging, unique characteristics of the product within the package, and environmental conditions (e.g., temperature, humidity, electrical interference).

With respect to the NFC IC device itself, the PUF may include an analog-to-digital converter (ADC) (FIG. 6, 672) that converts electromagnetic energy received on the antenna interfaces 640/642 (AP and AN) into digital signals that are provided to the controller 650. In an example, the ADC is dedicated to generating the digital signal signature and is functional at low-voltage power-up, and the sensitivity and dynamic range of the ADC are sufficient to encode at characteristic of the operating volume. In an example, the ADC that is used for generating the digital signal signature is distinct from any conventional NFC data decoding that is implemented by the NFC IC device. In an example, each tap of a mobile device onto an NFC label (which includes the NFC IC device) triggers the generation of a unique digital signal (e.g., referred to as a digital signal signature) in the form of a bitstring of binary bits. In an example, the digital signal signature is a set of bits that is extracted from a bitstream that is output from the ADC in response to a tap. In an example, the size of the set of bits of the digital signal signature is determined by how much of the operating volume needs to be encoded. For example, the number of bits of the digital signal signature may be proportional to the size of the operating volume, with a larger operating volume corresponding to more bits in the digital signal signature. In one example, the digital signal signature is 16 bits although digital signal signatures with a different number of bits are possible. In a case of a finite size operating volume, increasing the number of bits of a digital signal signature increases the encoded space density, and will at some level just add random least-significant bits (LSB) due to the relatively high noise floor of the NFC reader carrier signal. As described herein, each digital signal signature produced from a tap is unique and the unique digital signal signatures are used by the NFC IC device to generate the unique cipher codes (e.g., cipher code #1, cipher code #2, and cipher code #3 as described above).

The memory 652 includes non-volatile memory and at least a portion of the memory is a secure memory, such a secure element. The memory may store a URL, a label ID, and authentication keys, e.g., a seed key and an algorithmic key, or algorithmic keys. In an example, the label ID is unique to the NFC IC device and is stored into the memory at some point after the NFC IC device is fabricated. In an example, the authentication keys are stored in a secure area in the memory. In an example, the authentication keys are stored in a memory that is not readable by external devices. In an example, there is a secure memory space (secure memory) in a footer of the available addressable memory space of the memory, which cannot be read back from the NFC IC device once the NFC IC device is write-locked. In an example, the authentication keys are stored in the secure memory of the NFC IC device. For example, the authentication keys (e.g., seed key and algorithmic key) are stored in a secure element of the NFC IC device.

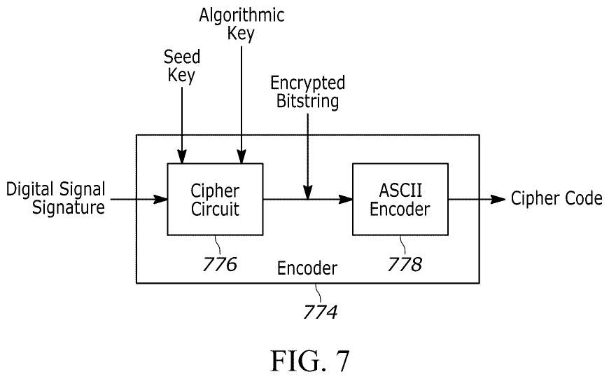

FIG. 7 is a functional block diagram of an encoder 774 of the NFC IC device 634 from FIG. 6 that is configured to generate a cipher code that can be used for product authentication. In an example, the encoder 774 is implemented in the controller 650 of the NFC IC device 634 and includes a cipher circuit 776 and an ASCII encoder 778. As illustrated in FIG. 7, the cipher circuit generates an encrypted bitstring from a digital signal signature using a seed key and an algorithmic key. In an example, the seed key is unique to the specific NFC IC device and both the seed key and the algorithmic key are accessed from a secure element of the NFC IC device. In an example operation, the cipher circuit applies Advanced Encryption Standard (AES) 128 encryption to the digital signal signature using the seed key and the algorithmic key and outputs the encrypted bitstring. In one example, the encoder uses a PUF random digital code “N” (e.g., the digital signal signature) to scramble cipher codes using an algorithm. For example, the controller loads an algorithmic key (e.g., used to determine how the algorithm shuffles) and a tag-specific (seed) key (e.g., a key that is unique to the NFC IC) from the memory into the encoder, and shuffles the cipher code “N” times. In an example, there are many cipher codes possible from a cipher code set by the two keys. The encrypted bitstring is provided to the ASCII encoder, which encodes the encrypted bitstring into a cipher code, which is in ASCII format. For example, the cipher code may be a cipher code as described with reference to FIG. 4 in which three separate taps result in the generation of three separate PUF-based cipher codes as follows:
Tap #1 cipher code: wwdffWGufeD;
Tap #2 cipher code: wVDEuUWtWDM; and
Tap #3 cipher code: aLXbcfMStNn.

Although AES 128 is provided as an example encryption scheme, other encryption schemes are possible. Additionally, although ASCII encoding is provided as an example encoding scheme, other encoding schemes are possible.

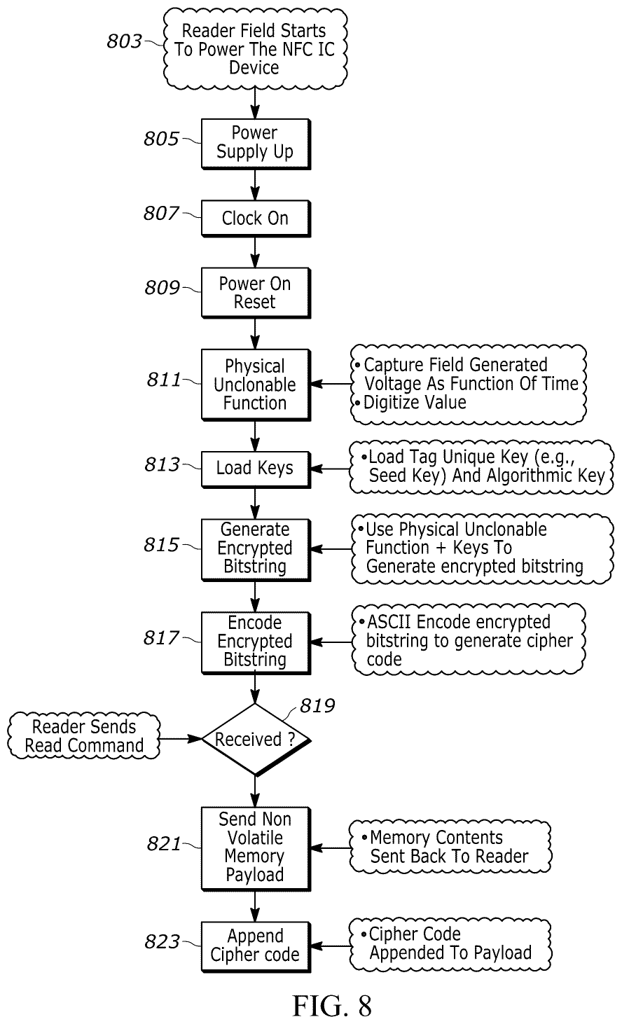

FIG. 8 illustrates an example of operations of an NFC IC device, such as the NFC IC device described herein, which are implemented as part of an authentication process.

In response to a reader field (e.g., from an NFC transceiver or NFC reader of a mobile device), which starts to power the NFC IC device (block 803), the NFC IC device implements the following operations:
1) power supply comes up (block 805);
2) the clock turns on (block 807);
3) the power on reset (POR) turns on (block 809);
4) the PUF performs operations (block 811) including 1) capturing a field generated voltage as a function of time; and 2) digitizing the captured voltage to produce a digital signal signature;
5) keys are loaded from the memory (block 813), including loading a tag-unique key (e.g., a seed key), and an algorithmic key;
6) the digitized value from the PUF (e.g., the digital signal signature) and the keys are used to generate an encrypted bitstring (block 815). In an example, a PUF value (N) is used to scramble cipher codes, e.g., the PUF value randomizes the number of operational go-around turns the cipher operation makes;
7) the encrypted bitstring is encoded (block 817), e.g., the encrypted bitstring is ASCII encoded;

In response to a read command (e.g., from the NFC transceiver or NFC reader of the mobile device) that is received at the NFC label (decision point 819);
8) the payload from the memory of the NFC IC device is sent to the NFC transceiver or NFC reader of the mobile device (block 821). For example, the NFC label sends a URL, a label ID (unique to the NFC label), and the ASCII encoded cipher code appended (block 823) to the URL and the label ID. For example, the NFC tag of the NFC label sends the URL, the label ID, and the cipher code to the mobile device in an NFC Data Exchange Format (NDEF) message via NFC communications. In an example, the NFC reader sends an NFC read command to the NFC label according to an NFC standard.

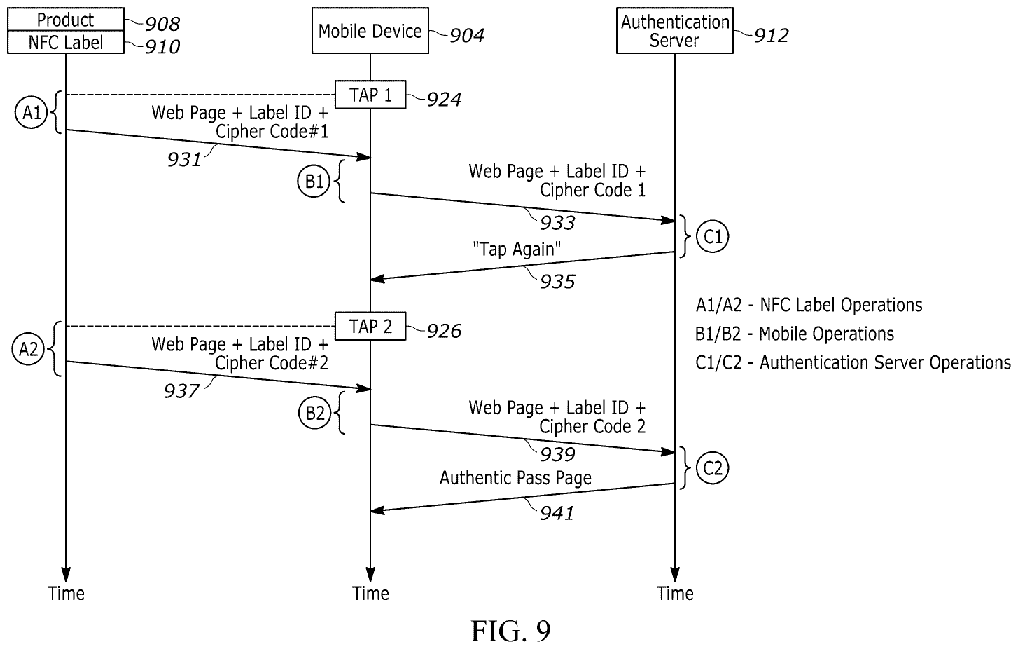

FIG. 9 is a swim lane diagram of a technique for authenticating a product that has an NFC label affixed thereon. In the example of FIG. 9, operations between an NFC label 910 that is affixed to a product 908, a mobile device 904 (e.g., an NFC-capable mobile device), and an authentication server 912 are illustrated in chronological order from top to bottom and the NFC label is an NFC label that is configured to generate interaction-specific cipher codes as described herein. With reference to FIG. 9, operations include:

1) The mobile device 904 is tapped onto the product 908 at the location of the NFC label 910, represented as Tap 1, 924. In some examples, the interaction/engagement between the mobile device and the NFC label is a tap of the mobile device on the NFC label, and in other examples, the interaction/engagement between the mobile device and the NFC label is the mobile device being brought into close proximity (e.g., less than about 10 centimeters) to the NFC label.

2) In response to the tap (Tap 1, 924), the NFC label 910 performs operations that are identified as “A1”. In an example, the A1 operations involve generating a cipher code (cipher code #1) from a digital signal signature that is generated at an NFC IC device of the NFC label in response to the tap (Tap 1). For example, cipher code #1 is generated from the digital signal signature and authentication keys (e.g., seed key and algorithmic key) that are stored at the NFC label (e.g., using the process described with reference to FIGS. 2-8). Next, the NFC label transmits information to the mobile device via NFC communications. For example, the transmitted information includes a webpage (e.g., URL), a label ID, and a cipher code (cipher code #1). In an example, the information (URL+label ID+cipher code #1) is transmitted from the NFC label to the mobile device in an NDEF message 931. In an example, the information is communicated between the analog front-end of the NFC IC device of the NFC label and an NFC transceiver or NFC reader of the mobile device.

3) In response to receiving the information (URL+label ID+cipher code #1) from the NFC label 910, the mobile device 904 performs operations B1. The operations B1 involve the mobile device transmitting the information to an authentication server in a message 933. For example, the mobile device transmits a message (e.g., an HTTPS message) that includes the webpage (e.g., URL), the label ID, and the cipher code #1 to the authentication server. In an example, the URL is used to access the authentication server and the information is communicated from the mobile device to a wired network via a cellular service or via WiFi. The mobile device may also use the URL to access a webpage that can be presented to the user.

4) The authentication server 912 receives the information (webpage (e.g., URL)+label ID+cipher code #1) sent from the mobile device and performs operations C1. For example, operations C1 may involve using the received information (e.g., the label ID and the cipher code #1) to authenticate the corresponding NFC label 910. In an example in which the NFC label is authenticated, the authentication server may provide a corresponding message to the mobile device.

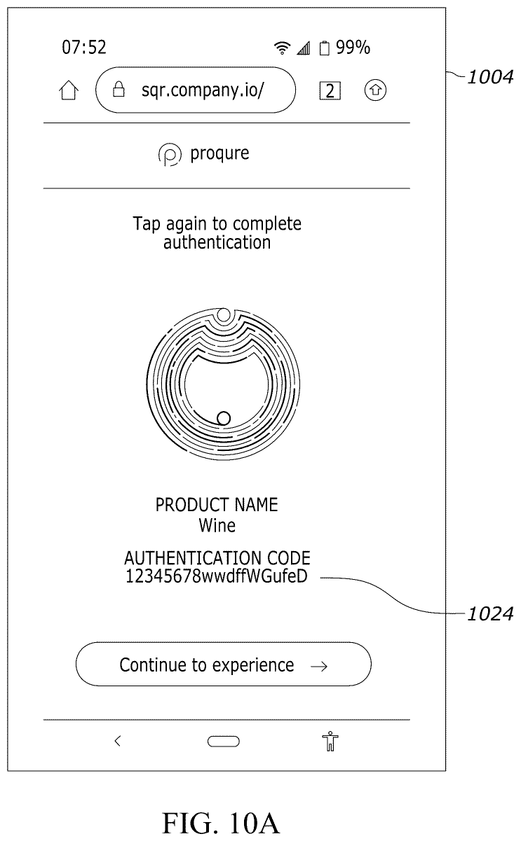

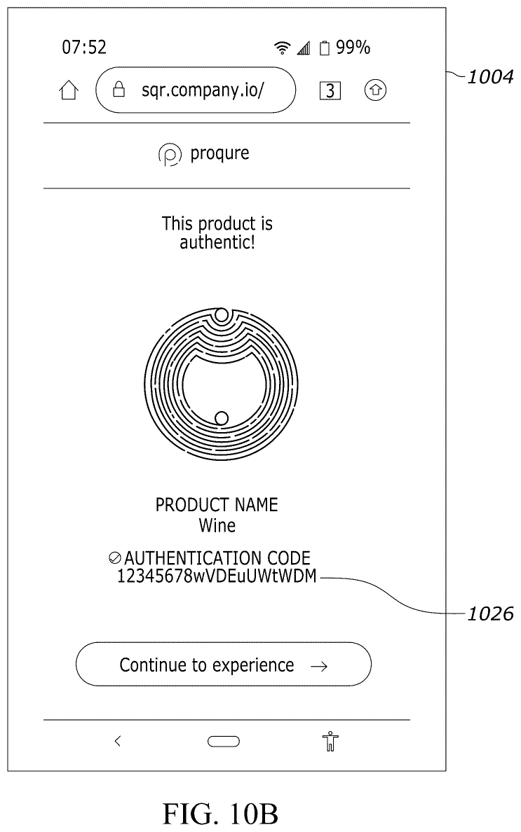

In another example in which the NFC label 910 passes a first authentication, the authentication server 912 may issue a message 935 (e.g., an HTTPS message) to the mobile device 904 to ask the user to “tap again” or to “engage again,” to initiate another authentication operation. For example, the authentication server may return a message to the mobile device that triggers the user to tap on the NFC label again. FIG. 10A is an example of a user interface that is displayed on the mobile device 1004 in response to a message received from the authentication server. In the example of FIG. 10A, the user interface includes an icon indicating that the user should tap again. The icon may include an explicit instruction such as a text instruction that reads “Tap again to complete authentication,” and/or an icon that indicates to the user that another tap should be implemented. In the example of FIG. 10A, the icon includes a graphic of an antenna in which a portion of the antenna is a color, e.g., green, with higher intensity brightness than other portions of the antenna graphic. In an example, the brighter intensity of the green coloring over only a portion of the antenna indicates to the user that authentication of the product is not complete. The user interface that is displayed on the mobile device in response to the message from the authentication server may include additional information such as the product name and an authentication code 1024, e.g., where the authentication code includes the label ID appended to the cipher code that was generated from the tap. The user interface may also include the URL that is the source of the message. In the example of FIG. 10A, the URL is displayed in a toolbar at the top of the display although the URL could be displayed somewhere else on the user interface. The display of the URL on the mobile device may provide assurance to the user that the user is receiving information from a trusted source.

5) Referring back to FIG. 9, in response to the tap again message 935, the mobile device 904 is tapped again (Tap 2, 926) onto the product 908 at the location of the NFC label 910. In some examples, the interaction is a tap of the mobile device on the NFC label, and in other examples, the interaction is the mobile device being brought into close proximity (e.g., less than about 10 centimeters) to the NFC label.

6) In response to the tap (Tap 2, 926), the NFC label 910 performs operations that are identified as “A2”. In an example, the A2 operations involve generating a cipher code (cipher code #2) from a digital signal signature that is generated at the NFC IC device of the NFC label in response to the tap (Tap 2) as described herein. For example, cipher code #2 is generated from the digital signal signature and authentication keys (e.g., seed key and algorithmic key) that are stored at the NFC label. Next, the NFC label transmits information to the mobile device 904. For example, the transmitted information includes a webpage (e.g., URL), a label ID, and a cipher code #2. In an example, the information (URL+label ID+cipher code #1) is transmitted from the NFC label to the mobile device in an NDEF message 937. For example, the information is communicated between an analog front end of the NFC IC device of the NFC label and an NFC transceiver or NFC reader of the mobile device. In an example, the second tap operation provides a way to ensure that NFC label can produce multiple different valid cipher codes, which provides protection against cloning.

7) In response to receiving the information (webpage (e.g., URL)+label ID+cipher code #2) from the NFC label 910, the mobile device 904 performs operations B2. The operations B2 involve the mobile device transmitting the information to the authentication server 912 in a message 939. For example, the mobile device transmits a message (e.g., an HTTPS message) that includes the webpage (e.g., URL), the label ID, and the cipher code #2 to the authentication server and the information is communicated from the mobile device to a wired network via a cellular service or via WiFi.

8) The authentication server 912 receives the information (webpage (e.g., URL)+label ID+cipher code #2) and performs operations C2. For example, operations C2 may involve using the received information (e.g., the label ID and the cipher code #2) to authenticate the NFC label 910. In the example of FIG. 9, the authentication server has authenticated the NFC label and a corresponding message 941 (e.g., an HTTPS message) is transmitted to the mobile device. In response to the message that is received at the mobile device, a message may be displayed on the mobile device that indicates to the user that the NFC label and/or product has been authenticated. FIG. 10B is an example of a user interface that is displayed on the mobile device 1004 in response to the message received from the authentication server. In the example of FIG. 10B, the user interface includes an icon indicating that the authentication was successful. The icon may include an explicit text message that reads “The product is authentic!,” and/or an icon that indicates to the user that the authentication was successful. In the example of FIG. 10B, the icon includes the graphic of the antenna in which the entire antenna is now a color, e.g., green, with high intensity brightness, e.g., the same intensity of brightness as the portions in FIG. 10A. In an example, the brighter intensity of the green coloring over the entire antenna indicates to the user that authentication of the product is complete. As with the user interface described with reference to FIG. 10A, the user interface that is displayed on the mobile device in response to the second message from the authentication server may include additional information such as the product name and an authentication code 1026, e.g., where the authentication code includes the label ID appended to the cipher code that was generated from the tap. The user interface may also include the URL that is the source of the message. In the example of FIG. 10B, the URL is displayed in a toolbar at the top of the display although the URL could be displayed somewhere else on the user interface. Again, the display of the URL on the mobile device may provide assurance to the user that the user is receiving information from a trusted source.

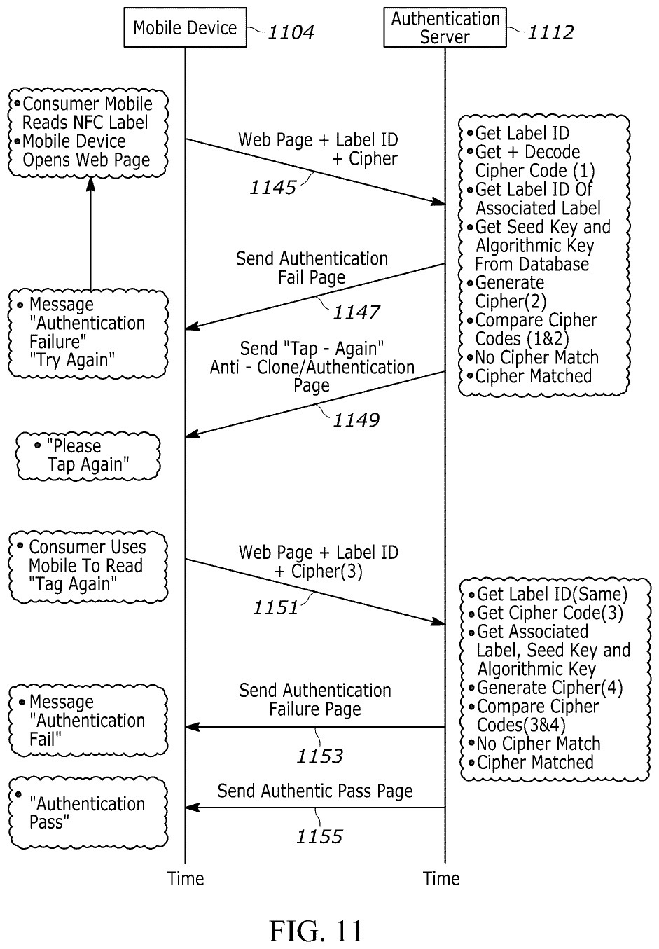

FIG. 11 is a swim lane diagram of a technique for authenticating a product that has an NFC label affixed thereon. In the example of FIG. 11, operations between a mobile device 1104 (e.g., an NFC-capable mobile device) and an authentication server 1112 are illustrated in chronological order from top to bottom. With reference to FIG. 11, operations include:

1) The mobile device 1104 (e.g., a smartphone) reads an NFC label (e.g., a tag that is affixed to a product) (not shown). The read operation results in the mobile device obtaining information that includes a URL, a label ID, and a cipher code from the NFC label as described herein. This information is provided to the authentication server via, for example, an HTTPS message 1145.

2) In response to the received information, the authentication server 1112 may perform operations including, GET label ID, GET+decode cipher code, GET label ID of associated label, get authentication keys (e.g., seed key and algorithmic key) from a database, generate cipher code, and compare received cipher code (1) to generated cipher code (2). In an example, the authentication keys are obtained using the label ID that is received from the mobile device 1104.

3) In an example, if the received cipher code does not match the generated cipher code, then the product is not authenticated and the authentication server may send a message 1147 (e.g., an HTTPS message) indicating that the authentication has failed.

4) If the received cipher code matches the generated cipher code, then the product may be authenticated. At this point, the authentication server may send a message (e.g., an HTTPS message) to the mobile device indicating that the product authentication has succeeded. However, in another example, the process includes an additional authentication operation, or operations, as indicated below. For example, the authentication server may send a message 1149 requesting the user to “tap again”. The message may include an anti-clone/authentication page. In an example, the “second tap” request and corresponding operations can be used to determine whether or not information in the NFC label has been cloned.

5) In response to the “tap again” message 1149, the user may tap the mobile device 1104 again on the NFC label that is affixed to the product.

6) The mobile device 1104 (e.g., a smartphone) reads the NFC label again. The read operation results in the mobile device obtaining a URL, a label ID, and a cipher code (cipher code #3) from the NFC label. This information is provided to the authentication server 1112 via, for example, an HTTPS message 1151. In an example, the NFC label generates the cipher code as described herein.

7) The authentication server 1112 may perform operations including, GET label ID (e.g., same label ID as above), GET cipher code #3, GET associated label ID and authentication keys (e.g., seed key and algorithmic key) from the database, generate cipher code (cipher code 4), and compare received cipher code (cipher code 3) to generated cipher code (cipher code 4). If the received cipher code (cipher code 3) does not match the generated cipher code (cipher code 4), then the product is not authenticated and if the received cipher code (cipher code 3) matches the generated cipher code (cipher code 4), then the product is authenticated. If the authentication fails, an authentication failure message 1153 (e.g., a first URL) is sent to the mobile device 1104. If the authentication succeeds, an authentication success message 1155 (e.g., a second URL) is sent to the mobile device.

Although examples of two “tap” operations are described with reference to FIGS. 9-11. More than two “tap” operations are possible. That is, the user could be prompted to tap the NFC label more than two times, which triggers the sequential generation of more than two unique cipher codes. In an example, each additional tap operation can increase the confidence of an authentication process. In an example, the number of taps involved in an authentication process may correspond to a sliding scale of confidence, with more taps corresponding to a higher level of confidence in the authentication result.

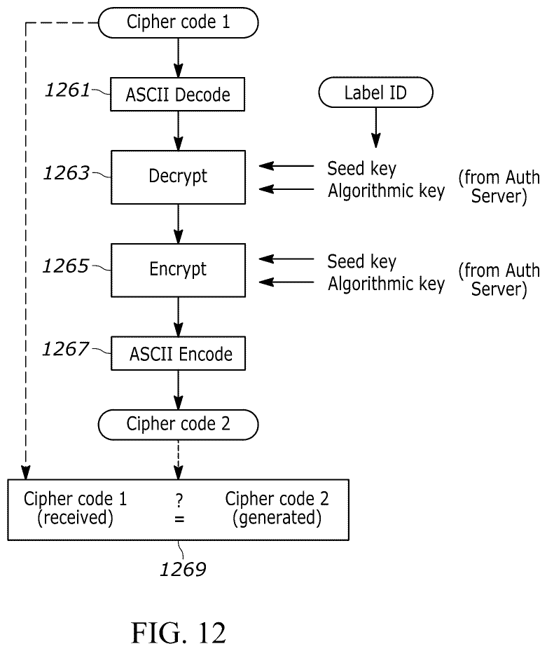

As described above, the authentication server checks to see if a cipher code that is received from a mobile device is a valid cipher code. In an example, the authentication server uses the label ID received in a message from the mobile device to obtain keys from a key database that are used to validate the cipher code. FIG. 12 is a process flow diagram of a method for validating a cipher code that is received from a mobile device that has interacted with an NFC label. In an example, the process is implemented by an authentication server. In an example, the cipher code (cipher code 1) is obtained from a message that is received from a mobile device. For example, the message includes a URL, a label ID, and a cipher code (cipher code 1) as described herein. In an example, the cipher code is an ASCII encoded cipher code as described with reference to FIGS. 4, 10A, and 10B. At block 1261, the cipher code is decoded (e.g., ASCII decoded) into an encrypted bitstring. At block 1263, the encrypted bitstring is decrypted. For example, the encrypted bitstring is decrypted using a seed key and/or an algorithmic key that are obtained using the label ID that was included in the message. It should be noted that if the cipher code was generated from an authentic NFC label, then the decrypted bitstring will match the portion of the digital signal signature that was generated by the NFC tag in response to a tap and used by the NFC IC device to generate the cipher code (cipher code 1).

In a next step, at block 1265, the decrypted bitstring that is output from the decryption operation (block 1263) is encrypted using a seed key and an algorithmic key that are obtained using the label ID that was included in the message. In one example, the seed key and the algorithmic key are obtained from a key database for the decryption operation (block 1263) and then the keys are obtained again from the key database for the encryption operation (block 1265), and in another example, the seed key and the algorithmic key are obtained once from the key database and used for both the decryption operation (block 1263) and the encryption operation (block 1265). In a next operation, at block 1267, the encrypted bitstring that is output from the encryption operation (bock 1265) is ASCII encoded to produce a cipher code (cipher code 2), such as an ASCII encoded cipher code. It should be noted that the encryption and decryption schemes used by the authentication server are the same as the encryption algorithm used by the NFC label. For example, both the NFC label and the authentication server use an AES 128 encryption/decryption scheme. In a next step, at block 1269, cipher code 1 (e.g., the cipher code received at the authentication server) is compared to cipher code 2 (e.g., the cipher code generated at the authentication server) to see if cipher code 1 and cipher code 2 match each other. If cipher code 1 and cipher code 2 match each other, then it can be inferred that the NFC label affixed to the product is an authentic NFC label and therefore the corresponding product is an authentic product. However, if cipher code 1 and cipher code 2 do not match each other, then it can be inferred that the NFC label affixed to the product is not an authentic NFC label and therefore the corresponding product is not an authentic product.

In an example, cipher code 1 and cipher code 2 will not match each other if the seed key and the algorithmic key that are used at the NFC label to generate cipher code 1 are not the same as the seed key and the algorithmic key that are used at the authentication server to generate cipher code 2. The seed key and algorithmic key that are used to generate cipher code 1 may not match the seed key and the algorithmic key that were used to generate cipher code 2 if, for example, the NFC label is not an authentic NFC label. Because the seed key and/or the algorithmic key are stored in secure memory of the NFC IC device of the NFC label, it is difficult for a counterfeiter to obtain the seed key and/or the algorithmic key from the NFC IC device itself.

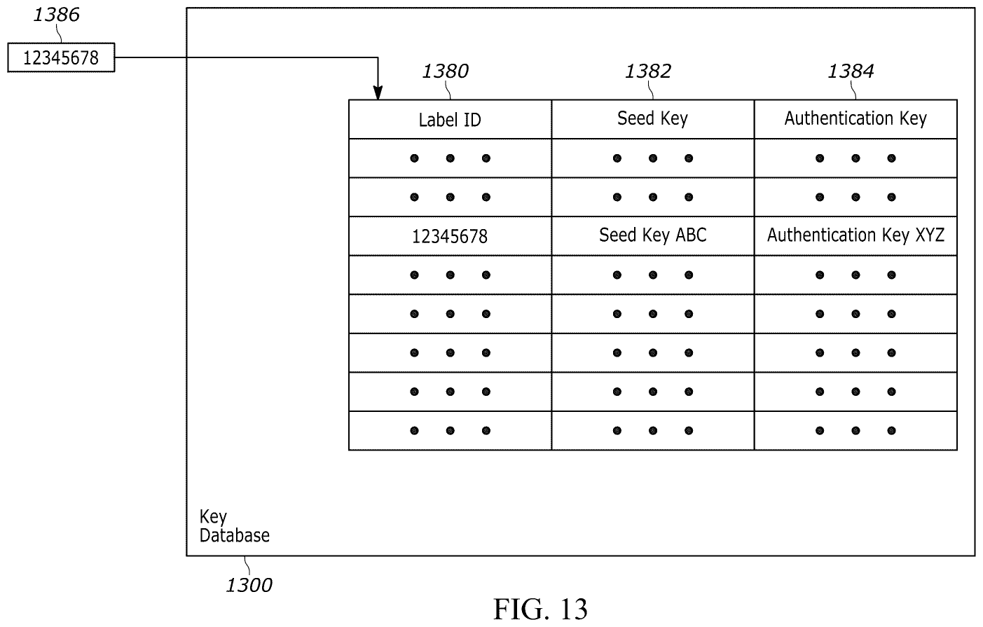

In an example, a key database is maintained at, or accessible by, the authentication server. FIG. 13 is an example of a key database 1300 that stores keys that are indexed by label ID. As shown in FIG. 13, the database includes a label ID column 1380, a seed key column 1382, and an algorithmic key column 1384. The seed keys and the algorithmic keys are searchable based on a label ID. In the example, label ID “12345678” 1386 returns seed key ABC and algorithmic key XYZ. Thus, each label ID can have a unique set of seed and algorithmic keys. Although only one entry is shown in the key database, the key database may include a large number of entries. In an example, a customer can establish a database of thousands of label IDs, with each label ID having a corresponding seed key and a corresponding algorithmic key. In an example, key databases are set up by customer and a customer is identified by a URL. Thus, in an example, there are URL-specific key databases and the URL is used to locate the corresponding key database and the label ID is used to search the URL-specific key database. The label IDs can be matched to specific NFC labels that are then programmed with the corresponding seed key and algorithmic key. A key database as described with reference to FIG. 13 may be accessed by an authentication server to authenticate an NFC label as described herein.

As described above, much of the processing to authenticate an NFC label is done at the authentication server. For example, the NFC label simply has to generate cipher codes from digital signal signatures and send a few messages to the mobile device. The authentication server is then tasked with decrypting the cipher codes, encrypting the cipher codes, and then comparing received and generated cipher codes to authenticate an NFC label. Because the operations performed at the NFC label are relatively simple, the NFC labels can be produced at a cost that enables vast retail adoption while cloud computing resources can be utilized to implement the authentication server operations in a cost effective manner.

In some applications, a single tap and corresponding cipher code may be sufficient to authenticate a product. However, a counterfeiter may be able to learn the URL, label ID, and a corresponding cipher code of a label by, for example, intercepting a communication between the mobile device and the authentication server. In such a case, a counterfeiter could create clones of an NFC label that include the same URL, label ID, and cipher code stored in the memory of each cloned NFC label and apply the cloned NFC labels to counterfeited products. In order to protect against cloning, the multi-tap authentication process is implemented. The multi-tap authentication approach makes cloning much more difficult because each interaction between the mobile device and the NFC label produces a unique cipher code as described above. That is, the unique electrical characteristics of a particular interaction between a mobile device and an NFC label correspond to a PUF that can be leveraged at the NFC label to produce PUF-based cipher codes. Leveraging the PUF that corresponds to interactions between a mobile device and an NFC label helps randomize the generated cipher codes, particularly if a human is bringing the mobile device into close proximity to the NFC label. For data analysis, a succession of identical cipher codes can be interpreted that the NFC label is a clone, an NFC label is being polled, or consistently being interrogated on automated equipment as would be the case under a replay or brute-force attack.

Although NFC is described as the wireless communications technology utilized between the mobile device and the NFC tag, it is possible that other wireless communications techniques could be used to implement the product authentications technique described herein. For example, Radio Frequency Identification (RFID) technologies could be used for wireless communications between the mobile device and the NFC tag.

Although an example of a bottle of wine is given as a product, the authentication techniques are applicable to any product or item that can be associated with an NFC label.

Although the term “cipher” is used throughout, the terms “cipher” and “cypher” are interchangeable.

### Particular Implementations

Described implementations of the subject matter can include one or more features, alone or in combination, as described in the following clauses.

Clause 1. A near field communication (NFC) integrated circuit (IC) device comprising:
an analog front end;
a digital controller; and
memory;
wherein;
the analog front end includes a physically unclonable function (PUF) configured to generate a digital signal signature from electromagnetic energy received at the analog front end; and
the digital controller is configured to generate a cipher code from the digital signal signature and at least one key.

Clause 2. The NFC IC device of clause 1 wherein:
the digital controller includes an encoder configured to generate the cipher code from the digital signal signature and from the at least one key, which is accessed from the memory;
the digital signal signature corresponds to a parameter of the electromagnetic energy received at the analog front end as a function of time;
a URL and a label ID are stored in the memory, wherein the label ID is unique to the NFC IC device; and
the digital controller is configured to provide a message to the analog front end for transmission, the message including the URL, the label ID, and the cipher code.

Clause 3. The NFC IC device of clause 2, wherein the digital controller is configured to generate a second cipher code from second electromagnetic energy received at the analog front end, and to provide a second message to the analog front end for transmission, the second message including the URL, the label ID, and the second cipher code.

Clause 4. The NFC IC device of clause 1, wherein the digital controller includes an encoder configured to generate the cipher code from the digital signal signature and the at least one key.

Clause 5. The NFC IC device of clause 1, wherein the at least one key is stored in the memory, and wherein the digital controller includes an encoder configured to generate the cipher code from the digital signal signature and the at least one key.

Clause 6. The NFC IC device of clause 1, wherein the at least one key includes a seed key and an algorithmic key that are stored in the memory, and wherein the digital controller includes an encoder configured to generate the cipher code from the digital signal signature, the seed key, and the algorithmic key.

Clause 7. The NFC IC device of clause 1, wherein the digital signal signature corresponds to a magnitude of the electromagnetic energy received at the analog front end as a function of time.

Clause 8. The NFC IC device of clause 1, wherein the digital signal signature corresponds to a voltage generated at the analog front end as a function of time in response to the electromagnetic energy received at the analog front end.

Clause 9. A near field communication (NFC) tag comprising:
an antenna; and
an NFC integrated circuit (IC) device coupled to the antenna, the NFC IC device including;
   an analog front end;
   a digital controller; and
   memory;
   wherein;
   the analog front end includes a physically unclonable function (PUF) configured to generate a digital signal signature from electromagnetic energy received at the analog front end via the antenna; and
   the digital controller is configured to generate a cipher code from the digital signal signature and at least one key.

Clause 10. The NFC IC device of clause 9, wherein:
the digital controller includes an encoder configured to generate the cipher code from the digital signal signature and from the at least one key, which is accessed from the memory;
the digital signal signature corresponds to a parameter of the electromagnetic energy received at the analog front end as a function of time;
a URL and a label ID are stored in the memory, wherein the label ID is unique to the NFC IC device; and
the digital controller is configured to provide a message to the analog front end for transmission via the antenna, the message including the URL, the label ID, and the cipher code.

Clause 11. The NFC IC device of clause 10, wherein the digital controller is configured to generate a second cipher code from second electromagnetic energy received at the analog front end, and to provide a second message to the analog front end for transmission, the second message including the URL, the label ID, and the second cipher code.

Clause 12. The NFC tag of clause 11, wherein the NFC tag is integrated with a label substrate.

Clause 13. A near field communication (NFC) tag comprising:
an antenna; and
an NFC integrated circuit (IC) device coupled to the antenna, the NFC IC device including;
   an analog front end;
   a digital controller; and
   memory that stores a URL, a label ID, a seed key, and an algorithmic key;
   wherein;
   the analog front end configured to generate a digital signal signature from electromagnetic energy received at the analog front end via the antenna, wherein the digital signal signature corresponds to a parameter of the electromagnetic energy received at the analog front end as a function of time; and
   the digital controller is configured to 1) generate a cipher code from the digital signal signature, the seed key, and the algorithmic key, and 2) provide a message to the analog front end for transmission via the antenna, the message including the URL, the label ID, and the cipher code.

Clause 14. The NFC tag of clause 13, wherein the digital controller in configured to generate a second cipher code and to provide a second message to the analog front end in response to receipt of second electromagnetic energy at the analog front end.

Clause 15. The NFC tag of clause 13, wherein the digital controller is configured to generate a second cipher code from second electromagnetic energy received at the analog front end using the seed key and the algorithmic key, and to provide a second message to the analog front end for transmission, the second message including the URL, the label ID, and the second cipher code.

Clause 16. A method for operating a near field communication (NFC) integrated circuit (IC) device, the method comprising:
receiving electromagnetic energy at an analog front end of the NFC IC device from a mobile device;
generating a digital signal signature from the electromagnetic energy received at the analog front end;
generating a cipher code from the digital signal signature and at least one key that is stored in the NFC IC device; and
transmitting the cipher code from the analog front end to the mobile device.

Clause 17. The method of clause 16, wherein the cipher code is transmitted in a message along with a URL and an identifier that is unique to the NFC IC device.

Clause 18. The method of clause 16, wherein the cipher code is transmitted in an NFC Data Exchange Format (NDEF) message along with a URL and an identifier that is unique to the NFC IC device.

Clause 19. The method of clause 16, wherein:
the cipher code is transmitted in a message that includes a URL and an identifier that is unique to the NFC IC device;
further comprising, after transmitting the message from the analog front end:
receiving second electromagnetic energy at the analog front end of the NFC IC device;
generating a second digital signal signature from the second electromagnetic energy received at the analog front end;
generating a second cipher code from the second digital signal signature and from the at least one key; and
transmitting a second message from the analog front end that includes the URL, the identifier, and the second cipher code.

Clause 20. The method of clause 16, wherein the cipher code is generated in response to the digital signal signature, a seed key, and an algorithmic key, wherein the seed key and the algorithmic key are stored in a secure memory of the NFC IC device.

Clause 21. A method for authenticating a near field communication (NFC) label, the method comprising:
receiving a first message that includes a label ID and a first cipher code from a mobile device;
generating a second cipher code in response to receiving the first message;
transmitting an engage again message to the mobile device in response to determining that the first cipher code matches the second cipher code;
receiving a second message that includes a label ID and a third cipher code from the mobile device after the engage again message is transmitted to the mobile device;
generating a fourth cipher code in response to receiving the second message; and
transmitting an authentication successful message to the mobile device in response to determining that the third cipher code matches the fourth cipher code.

Clause 22. The method of clause 21, wherein:
the second cipher code is generated from the first cipher code using at least one key that is obtained using the label ID that is received in the first message; and
the fourth cipher code is generated from the third cipher code using at least one key that is obtained using the label ID that is received in the second message.

Clause 23. The method of clause 21, wherein:
generating the second cipher code involves decoding the first cipher code using at least one key that is obtained using the label ID that is received in the first message to produce a decoded output and encoding the decoded output using the at least one key to generate the second cipher code; and
generating the fourth cipher code involves decoding the third cipher code using at least one key that is obtained using the label ID that is received in the second message to produce a decoded output and encoding the decoded output using the at least one key to generate the fourth cipher code.

Clause 24. The method of clause 23, further comprising comparing the first cipher code to the second cipher code at an authentication server, and comparing the third cipher code to the fourth cipher code at the authentication server.

Clause 25. The method of claim 21, wherein the first message includes a URL and the second message includes a URL, wherein the URL in the first message matches the URL in the second message, and further comprising comparing the first cipher code to the second cipher code at an authentication server that is accessed via the URL, and comparing the third cipher code to the fourth cipher code at the authentication server.

Clause 26. The method of clause 25, wherein the authentication server includes a database of keys that are indexed by label ID.

Clause 27. The method of clause 26, wherein the authentication server is configured to generate the second cipher code and the fourth cipher code using an encryption algorithm, which is the same as an encryption algorithm that is used by an NFC IC device that corresponds to the label ID.

Clause 28. The method of clause 21, wherein the label ID received in the first message matches the label ID received in the second message, and wherein the second cipher code and the fourth cipher code are generated from a key that is obtained using the label ID.

Clause 29. The method of clause 21, wherein the first cipher code and the third cipher code are generated at an NFC label that is affixed to a product and wherein the NFC label receives electromagnetic energy from the mobile device.

Clause 30. A method for authenticating an NFC label, the method comprising:
receiving a first message that includes a label ID and a first cipher code from a mobile device;
generating a second cipher code from the first cipher code using the label ID from the first message;
determining if the first cipher code matches the second cipher code;
transmitting an engage again message to the mobile device in response to determining that the first cipher code matches the second cipher code, or an authentication failed message to the mobile device in response to determining that the first cipher code does not match the second cipher code;
receiving a second message that includes a label ID and a third cipher code from the mobile device after the engage again message is transmitted to the mobile device;
generating a fourth cipher code from the third cipher code using the label ID from the second message;
determining if the third cipher code matches the fourth cipher code; and
transmitting an authentication successful message to the mobile device in response to determining that the third cipher code matches the fourth cipher code, or an authentication failed message to the mobile device in response to determining that the first cipher code does not match the second cipher code.

Clause 31. The method of clause 30, wherein:
generating the second cipher code involves decoding the first cipher code using at least one key that is obtained using the label ID that is received in the first message to produce a decoded output and encoding the decoded output using the at least one key to generate the second cipher code; and
generating the fourth cipher code involves decoding the third cipher code using at least one key that is obtained using the label ID that is received in the second message to produce a decoded output and encoding the decoded output using the at least one key to generate the fourth cipher code.

Clause 32. The method of clause 31, further comprising comparing the first cipher code to the second cipher code at an authentication server, and comparing the third cipher code to the fourth cipher code at the authentication server.

Clause 33. The method of claim 32, wherein the first cipher code and the third cipher code are generated in an NFC label that is affixed to a product and wherein the NFC label receives electromagnetic energy from the mobile device.

Clause 34. A method for authenticating an NFC label, the method comprising:
at an authentication server;
receiving a label ID and a first cipher code from a mobile device;
generating a second cipher code from the first cipher code using the label ID received with the first cipher code;
generating an engage again message for transmission to the mobile device in response to determining that the first cipher code matches the second cipher code;
receiving a label ID and a third cipher code from the mobile device after the engage again message is transmitted to the mobile device;
generating a fourth cipher code from the third cipher code using the label ID received with the third cipher code; and
generating an authentication successful message for transmission to the mobile device in response to determining that the third cipher code matches the fourth cipher code.

Clause 35. The method of clause 34, wherein:
the second cipher code is generated from the first cipher code using at least one key that is obtained using the label ID that is received with the first cipher code; and
the fourth cipher code is generated from the third cipher code using at least one key that is obtained using the label ID that is received with the third cipher code.

Clause 36. The method of claim 34, wherein:
generating the second cipher code involves decoding the first cipher code using at least one key that is obtained using the label ID that is received with the first cipher code to produce a decoded output and encoding the decoded output using the at least one key to generate the second cipher code; and
generating the fourth cipher code involves decoding the third cipher code using at least one key that is obtained using the label ID that is received with the third cipher code to produce a decoded output and encoding the decoded output using the at least one key to generate the fourth cipher code.

Clause 37. The method of clause 36, further comprising comparing the first cipher code to the second cipher code at an authentication server, and comparing the third cipher code to the fourth cipher code at the authentication server.

Clause 38. The method of claim 37, wherein the authentication server includes a database of keys that are indexed by label ID.

Clause 39. The method of claim 38, wherein the authentication server is configured to generate the second cipher code and the fourth cipher code using an encryption algorithm that is also used by an NFC IC device that corresponds to the label ID.

Clause 40. The method of claim 39, wherein the first cipher code and the second cipher code are generated in an NFC label that is affixed to a product and wherein the NFC label receives electromagnetic energy from the mobile device.

Clause 41. A method for authenticating a near field communication (NFC) label, the method comprising:
receiving a first message that includes a label ID and a first cipher code from a mobile device;
obtaining a seed key and an algorithmic key using the label ID;
generating a second cipher code from the first cipher code using the seed key and the algorithmic key that were obtained using the label ID; and
authenticating the NFC label in response to the second cipher code matching the first cipher code.

The connections as discussed herein may be any type of connection suitable to transfer signals or power from or to the respective nodes, units, or devices, including via intermediate devices. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. The term “coupled” or similar language may include a direct physical connection or a connection through other intermediate components even when those intermediate components change the form of coupling from source to destination.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program. The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for authenticating a near field communication (NFC) label, the method comprising:
receiving a first message that includes a label ID and a first cipher code from a mobile device;
generating a second cipher code in response to receiving the first message;
transmitting an engage again message to the mobile device in response to determining that the first cipher code matches the second cipher code;
receiving a second message that includes a label ID and a third cipher code from the mobile device after the engage again message is transmitted to the mobile device;
generating a fourth cipher code in response to receiving the second message; and
transmitting an authentication successful message to the mobile device in response to determining that the third cipher code matches the fourth cipher code.

2. The method of claim 1, wherein:
the second cipher code is generated from the first cipher code using at least one key that is obtained using the label ID that is received in the first message; and
the fourth cipher code is generated from the third cipher code using at least one key that is obtained using the label ID that is received in the second message.

3. The method of claim 1, wherein:
generating the second cipher code involves decoding the first cipher code using at least one key that is obtained using the label ID that is received in the first message to produce a decoded output and encoding the decoded output using the at least one key to generate the second cipher code; and
generating the fourth cipher code involves decoding the third cipher code using at least one key that is obtained using the label ID that is received in the second message to produce a decoded output and encoding the decoded output using the at least one key to generate the fourth cipher code.

4. The method of claim 3, further comprising comparing the first cipher code to the second cipher code at an authentication server, and comparing the third cipher code to the fourth cipher code at the authentication server.

5. The method of claim 1, wherein the first message includes a URL and the second message includes a URL, wherein the URL in the first message matches the URL in the second message, and further comprising comparing the first cipher code to the second cipher code at an authentication server that is accessed via the URL, and comparing the third cipher code to the fourth cipher code at the authentication server.

6. The method of claim 5, wherein the authentication server includes a database of keys that are indexed by label ID.

7. The method of claim 6, wherein the authentication server is configured to generate the second cipher code and the fourth cipher code using an encryption algorithm, which is the same as an encryption algorithm that is used by an NFC IC device that corresponds to the label ID.

8. The method of claim 1, wherein the label ID received in the first message matches the label ID received in the second message, and wherein the second cipher code and the fourth cipher code are generated from a key that is obtained using the label ID.

9. The method of claim 1, wherein the first cipher code and the third cipher code are generated at an NFC label that is affixed to a product and wherein the NFC label receives electromagnetic energy from the mobile device.

10. A method for authenticating an NFC label, the method comprising:
receiving a first message that includes a label ID and a first cipher code from a mobile device;
generating a second cipher code from the first cipher code using the label ID from the first message;
determining if the first cipher code matches the second cipher code;
transmitting an engage again message to the mobile device in response to determining that the first cipher code matches the second cipher code, or an authentication failed message to the mobile device in response to determining that the first cipher code does not match the second cipher code;
receiving a second message that includes a label ID and a third cipher code from the mobile device after the engage again message is transmitted to the mobile device;
generating a fourth cipher code from the third cipher code using the label ID from the second message;
determining if the third cipher code matches the fourth cipher code; and
transmitting an authentication successful message to the mobile device in response to determining that the third cipher code matches the fourth cipher code, or an authentication failed message to the mobile device in response to determining that the first cipher code does not match the second cipher code.

11. The method of claim 10, wherein:
generating the second cipher code involves decoding the first cipher code using at least one key that is obtained using the label ID that is received in the first message to produce a decoded output and encoding the decoded output using the at least one key to generate the second cipher code; and
generating the fourth cipher code involves decoding the third cipher code using at least one key that is obtained using the label ID that is received in the second message to produce a decoded output and encoding the decoded output using the at least one key to generate the fourth cipher code.

12. The method of claim 11, further comprising comparing the first cipher code to the second cipher code at an authentication server, and comparing the third cipher code to the fourth cipher code at the authentication server.

13. The method of claim 12, wherein the first cipher code and the third cipher code are generated in an NFC label that is affixed to a product and wherein the NFC label receives electromagnetic energy from the mobile device.

14. A method for authenticating an NFC label, the method comprising:
at an authentication server;
receiving a label ID and a first cipher code from a mobile device;
generating a second cipher code from the first cipher code using the label ID received with the first cipher code;
generating an engage again message for transmission to the mobile device in response to determining that the first cipher code matches the second cipher code;
receiving a label ID and a third cipher code from the mobile device after the engage again message is transmitted to the mobile device;
generating a fourth cipher code from the third cipher code using the label ID received with the third cipher code; and
generating an authentication successful message for transmission to the mobile device in response to determining that the third cipher code matches the fourth cipher code.

15. The method of claim 14, wherein:
the second cipher code is generated from the first cipher code using at least one key that is obtained using the label ID that is received with the first cipher code; and
the fourth cipher code is generated from the third cipher code using at least one key that is obtained using the label ID that is received with the third cipher code.

16. The method of claim 14, wherein:
generating the second cipher code involves decoding the first cipher code using at least one key that is obtained using the label ID that is received with the first cipher code to produce a decoded output and encoding the decoded output using the at least one key to generate the second cipher code; and
generating the fourth cipher code involves decoding the third cipher code using at least one key that is obtained using the label ID that is received with the third cipher code to produce a decoded output and encoding the decoded output using the at least one key to generate the fourth cipher code.

17. The method of claim 16, further comprising comparing the first cipher code to the second cipher code at an authentication server, and comparing the third cipher code to the fourth cipher code at the authentication server.

18. The method of claim 17, wherein the authentication server includes a database of keys that are indexed by label ID.

19. The method of claim 18, wherein the authentication server is configured to generate the second cipher code and the fourth cipher code using an encryption algorithm that is also used by an NFC IC device that corresponds to the label ID.

20. The method of claim 19, wherein the first cipher code and the second cipher code are generated in an NFC label that is affixed to a product and wherein the NFC label receives electromagnetic energy from the mobile device.

21. A method for authenticating a near field communication (NFC) label, the method comprising:
receiving a first message that includes a label ID and a first cipher code from a mobile device;
obtaining a seed key and an algorithmic key using the label ID;
generating a second cipher code from the first cipher code using the seed key and the algorithmic key that were obtained using the label ID; and
authenticating the NFC label in response to the second cipher code matching the first cipher code.
